(19) United States
(12) Patent Application Publication
(10) Pub. No.: US 2013/0057552 A1
(43) Pub. Date: Mar. 7, 2013

(54) DRAWING APPARATUS AND DRAWING METHOD

(71) Applicants: Takao YOSHIWA, Kyoto (JP); Yoshinori HONJO, Kyoto (JP)

(72) Inventors: Takao YOSHIWA, Kyoto (JP); Yoshinori HONJO, Kyoto (JP)

(21) Appl. No.: 13/599,432

(22) Filed: Aug. 30, 2012

(30) Foreign Application Priority Data
Sep. 7, 2011 (JP) P2011-194848

(51) Int. Cl. G06T 11/20

(52) U.S. Cl. 345/441

(57) ABSTRACT

A data converter (811) rasterizes vector data indicating an entirety of each of patterns to generate drawing raster data, and generates partial raster data which is raster data indicating a feature area for pattern identification in each of the patterns at the time of generating the drawing raster data. A set of the drawing raster data and the partial raster data is treated as a drawing data set (51), and a plurality of drawing data sets (51) respectively corresponding to a plurality of patterns are stored in a memory (821). A display controller (601) causes an image showing a feature area in a selected pattern out of the plurality of patterns to be easily and speedily displayed on a display (602), based on the partial raster data included in the same drawing data set (51) that includes the drawing raster data indicating the selected pattern.

### TECHNICAL FIELD

The present invention relates to a drawing apparatus and a drawing method for drawing a pattern.

### BACKGROUND ART

Conventionally, vector data of a pattern which is created by CAD (computer aided design) is rasterized to generate drawing raster data, and then the pattern is drawn on a photosensitive material covering a substrate by a drawing part in accordance with the drawing raster data. Also, as a certain period of time is required to draw and develop a pattern, a process of checking whether or not selected drawing raster data indicates a desired pattern is performed before drawing a pattern, as needed.

In this regard, Japanese Patent Application Laid-Open No.2006-330184 discloses a method for achieving labor savings in visual check of raster data used for drawing. According to this method, before vector-format Gerber data indicating a wiring pattern which is to be drawn directly on a substrate is converted into raster data used for drawing by raster image processing (RIP), upon designation of an arbitrary detail display range, only data corresponding to the designated detail display range in the Gerber data is converted into raster data with high resolution. Then, a detail display image which shows a wiring pattern within the detail display range appears on a raster display screen. Further, Japanese Patent Application Laid-Open No.2008-153572 discloses a method, in which an image data of an alignment mark formed on a surface of an object under inspection is taken, a correlation value is calculated from features extracted from the image data and features of the alignment mark which have previously been recorded, and the image data of the alignment mark used for alignment is recorded based on a threshold of the calculated correlation value.

In the meantime, one possible approach to a check of a pattern indicated by selected drawing raster data before pattern drawing is to prepare a thumbnail showing an entirety of the pattern (miniature image showing an entirety) and display the thumbnail on a screen. In this approach, however, differences in minute pattern elements cannot be recognized, so that the pattern cannot be satisfactorily checked. Also, another possible approach is to display drawing raster data or an image obtained by reducing the resolution of drawing raster data to some degree (for example, a pixel-skipped image) on a screen. In this another approach, however, it is necessary to repeat scale-up/down of a displayed image and shift of a displayed region many times in order to find out a characteristic area which should be checked (which will hereinafter be referred to a “feature area”), so that a long period of time is required for checking. Furthermore, if a pattern is complicated, it is difficult for the others than a designer of the pattern to find out a feature area. As well, to extract an approximate mark in drawing raster data from a recorded mark requires a long period of time.

### SUMMARY OF INVENTION

The present invention is intended for a drawing apparatus for drawing a pattern, and it is an object of the present invention to speedily and easily display an image showing a feature area in a selected pattern.

A drawing apparatus according to the present invention, includes a data converter for generating drawing raster data by rasterizing vector data indicating an entirety of each pattern, and generating positional data of a feature area included in the each pattern or partial data indicating the feature area at the time of generating the drawing raster data, the feature area being used for pattern identification; a memory for storing a plurality of drawing data sets respectively corresponding to a plurality of patterns, each of the plurality of drawing data sets including a set of the drawing raster data, and the positional data or the partial data; a display controller for displaying an image showing a feature area in a selected pattern out of the plurality of patterns, on a displaying part, based on positional data or partial data which is included in the same drawing data set that includes drawing raster data indicating the selected pattern; and a drawing part for drawing a pattern on an object in accordance with drawing raster data.

According to the present invention, it is possible to speedily and easily display an image showing a feature area in a selected pattern.

According to a preferred embodiment of the present invention, partial data included in one drawing data set is raster data which indicates an image obtained by adding reference information to an image showing a feature area. As a result, it is possible to speedily display an image which shows a feature area and further includes reference information.

According to another preferred embodiment of the present invention, one drawing data set includes drawing raster data and partial raster data, in revising a pattern corresponding to the drawing data set, the data converter generates revised drawing raster data by rasterizing vector data indicating an entirety of a revised pattern, and generates revised partial raster data at the time of generating the revised drawing raster data, the revised partial raster data indicating the same feature area in the revised pattern as is indicated by the partial raster data, the drawing raster data is revised to the revised drawing raster data in the drawing data set, and the drawing data set includes both of the partial raster data and the revised partial raster data, and when the revised pattern is selected, an image indicated by the partial raster data and an image indicated by the revised partial raster data are ready for being displayed on the displaying part by the display controller. As a result, it is possible to easily display images showing feature areas in an unrevised pattern and a revised pattern.

According to still another preferred embodiment of the present invention, each drawing data set includes positional data of a plurality of feature areas or partial raster data indicating each of the plurality of feature areas, and when a pattern corresponding to the each drawing data set is selected, a plurality of images respectively showing a plurality of feature areas in the pattern are ready for being individually displayed on the displaying part by the display controller.

The present invention is also intended for a drawing method for drawing a pattern.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a block diagram illustrating a structure of a drawing apparatus;

FIG. 2 is a front view of the drawing apparatus;

FIG. 3 is a plan view of the drawing apparatus;

FIG. 4 is a functional block diagram illustrating generation and selection of data used for drawing;

FIG. 5 is a flow chart illustrating a process of drawing a pattern on a substrate;

FIG. 6 is a flow chart illustrating a process of preparing a drawing data set;

FIG. 7 is a flow chart illustrating a process of creating job data;

FIG. 8 illustrates a job creation window;

FIG. 9 illustrates a drawing data selection window;

FIG. 10 illustrates an entire image window; and

FIG. 11 illustrates a feature area window.

### DESCRIPTION OF EMBODIMENTS

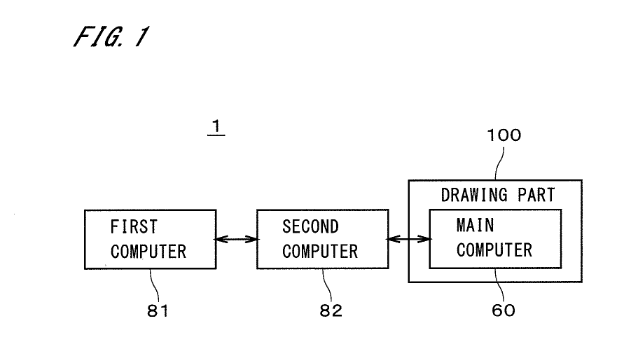

FIG. 1 is a block diagram illustrating a structure of a drawing apparatus 1 according to one preferred embodiment of the present invention. The drawing apparatus 1 includes first and second computers 81 and 82 for generating and storing data used for drawing, and a drawing part 100 for drawing a pattern on a substrate which serves as an object. Each of the first and second computers 81 and 82 and a main computer 60 of the drawing part 100 includes a CPU for performing various computations, a RAM for storing a variety of information, and the like. The functions fulfilled by the first and second computers 81 and 82 and the main computer 60 will be later described in detail.

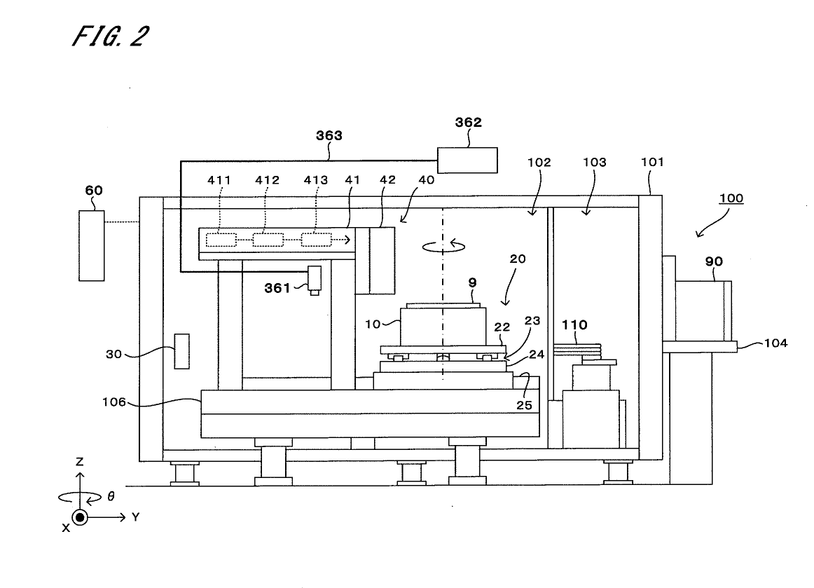

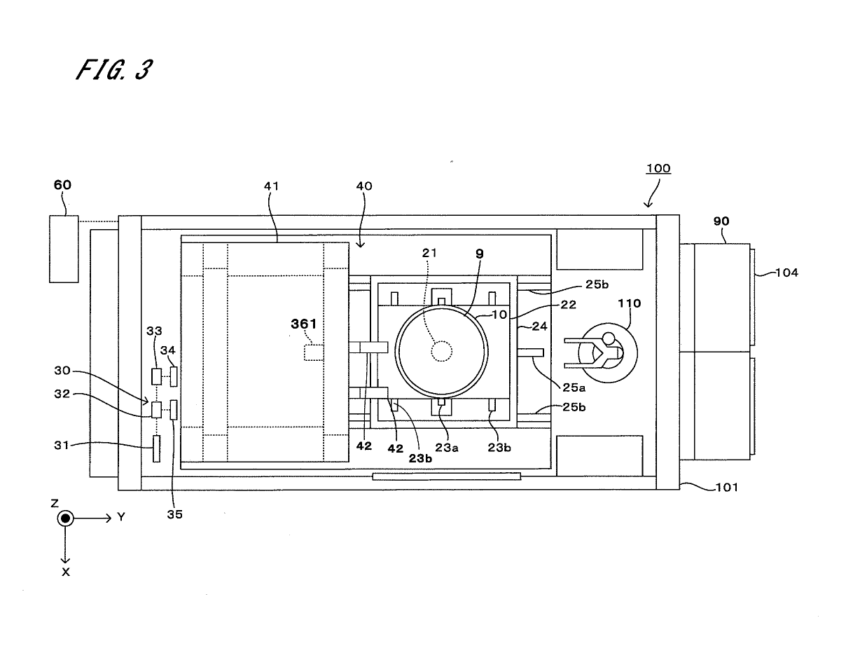

FIG. 2 is a front view of the drawing part 100, and FIG. 3 is a plan view of the drawing part 100. The drawing part 100 applies light to a drawing surface which is an upper surface of a semiconductor substrate 9 which is covered with a layer of photosensitive material such as resist, and draws a pattern on the drawing surface. In this regard, the substrate 9 may be any other substrate such as a printed circuit board, a substrate used for a color filter, a glass substrate used for a flat-panel display which is equipped in a liquid crystal display or a plasma display, or a substrate used for an optical disk. In an example illustrated in FIGS. 2 and 3, a pattern is drawn on a base pattern formed on a surface of a circular semiconductor substrate. The thus drawn pattern is a wiring pattern extending from an integrated circuit for allowing the integrated circuit to be externally connected, for example.

In the drawing part 100, the inside of a body is formed by attaching covering panels (not illustrated) to a ceiling surface and a surrounding surface of a skeleton of a body frame 101, and various kinds of elements are placed in the inside and the outside of the body. The inside of the body of the drawing part 100 illustrated in FIG. 2 is partitioned into a processing area 102 and a transfer area 103. Out of the two areas, in the processing area 102, a stage 10, a stage movement mechanism 20, a stage position measuring part 30, an optical unit 40, an alignment unit 361, and the main computer 60 serving as a control part, are placed. It is additionally noted that the main computer 60 is illustrated in the outside of the body in FIGS. 2 and 3. In the transfer area 103 in FIG. 2, a carrier device 110 for carrying the substrate 9 into or out of the processing area 102, such as a carrying robot, is placed. The main computer 60 is electrically connected with the foregoing elements (drawing engines) included in the drawing part 100, and controls operations of those elements.

In the outside of the body of the drawing part 100, a lighting unit 362 is placed. The lighting unit 362 supplies illuminating light to the alignment unit 361.

Also in the outside of the drawing part 100, a cassette holder 104 is placed at a position adjacent to the transfer area 103. A cassette 90 is mounted into the cassette holder 104. The carrier device 110 is placed at a position facing the cassette holder 104, so that the carrier device 110 takes out the unprocessed substrate 9 housed in the cassette 90 mounted into the cassette holder 104, and carries the substrate 9 into the processing area 102 (loading). Also, the carrier device 110 carries out the processed substrate 9 from the processing area 102 (unloading), then to house the substrate 9 in the cassette 90. The cassette 90 is carried into and out of the cassette holder 104 by an external carrier device not illustrated. Loading of the unprocessed substrate 9 and unloading of the processed substrate 9 are achieved by operations of the carrier device 110 in accordance with instructions provided from the main computer 60.

The stage 10 has a plate-like shape, and serves as a supporting part for supporting the substrate 9 placed on the upper surface thereof in a horizontal position. In the upper surface of the stage 10, a plurality of suction holes are formed, and to apply a negative pressure (suction pressure) to the suction holes allows the substrate 9 placed on the stage 10 to be fixed to the upper surface of the stage 10 and be supported. Any other mechanism for supporting the substrate 9 can be employed. The stage 10 is horizontally moved by the stage movement mechanism 20.

The stage movement mechanism 20 moves the stage 10 in a main scanning direction (a direction of Y-axis), a sub-scanning direction (a direction of X-axis), and a rotational direction (a direction of rotation about Z-axis (a direction of θ-axis). As a result of this, the substrate 9 supported by the stage 10 moves relatively to the optical unit 40. As illustrated in FIGS. 2 and 3, the stage movement mechanism 20 includes a rotation mechanism 21 for rotating the stage 10, a supporting plate 22 for supporting the rotation mechanism 21, a sub-scanning mechanism 23 for moving the supporting plate 22 in the sub-scanning direction, a base plate 24 for supporting the sub-scanning mechanism 23, and a main scanning mechanism 25 for moving the base plate 24 in the main scanning direction. The rotation mechanism 21 rotates the stage 10 about a rotation axis perpendicular to the upper surface of the substrate 9, on the supporting plate 22. The rotation mechanism 21, the sub-scanning mechanism 23, and the main scanning mechanism 25 are electrically connected with the main computer 60, and move the stage 10 in accordance with instructions provided from the main computer 60.

As illustrated in FIG. 3, the sub-scanning mechanism 23 includes a linear motor 23a. The linear motor 23a includes a slider attached to a lower surface of the supporting plate 22 and a stator placed on an upper surface of the base plate 24. Also, a pair of guide parts 23b extending in the sub-scanning direction X are provided between the supporting plate 22 and the base plate 24. Upon operation of the linear motor 23a, the supporting plate 22 moves in the sub-scanning direction X along the guide parts 23b.

The main scanning mechanism 25 includes a linear motor 25a. The linear motor 25a includes a slider attached to a lower surface of the base plate 24 and a stator placed on a base 106 (refer to FIG. 2) of the drawing part 100. Also, a pair of guide parts 25b extending in the main scanning direction are provided between the base plate 24 and the base 106. Upon operation of the linear motor 25a, the base plate 24 moves in the main scanning direction Y along the guide parts 25b on the base 106.

The stage position measuring part 30 measures a position of the stage 10. The stage position measuring part 30 is electrically connected with the main computer 60, and measures a position of the stage 10 in accordance with instructions provided from the main computer 60. The stage position measuring part 30 applies laser light toward the stage 10 and utilizes interference between reflected light and emitted light at that time, to measure a position of the stage 10, for example. However, the structure and operations of the stage position measuring part 30 are not limited to the foregoing description. According to the preferred embodiment, the stage position measuring part 30 includes an emitter 31 for emitting laser light, a beam splitter 32, a beam bender 33, a first interferometer 34, and a second interferometer 35. The emitter 31 and the interferometers 34 and 35 are electrically connected with the main computer 60, and measure a position of the stage 10 in accordance with instructions provided from the main computer 60.

Laser light emitted from the emitter 31 is incident upon the beam splitter 32, and then is branched into first branch light traveling toward the beam bender 33 and second branch light traveling toward the second interferometer 35. The first branch light is used for obtaining a positional parameter corresponding to a first region of the stage 10 in the first interferometer 34. The second branch light is used for obtaining a positional parameter corresponding to a second region of the stage 10 (please note that the second region is different from the first region) in the second interferometer 35. The main computer 60 attains the positional parameters respectively corresponding to the first and second regions of the stage 10 from the first interferometer 34 and the second interferometer 35. Then, the main computer 60 calculates a position of the stage 10 using the respective positional parameters.

The alignment unit 361 illustrated in FIG. 2 captures an image of a reference mark formed on the upper surface of the substrate 9. The alignment unit 361 includes a barrel, an objective lens, and a CCD image sensor. The CCD image sensor is an area image sensor (two-dimensional image sensor), for example.

The lighting unit 362 is connected with the alignment unit 361 via a fiber 363, and supplies light for illumination to the alignment unit 361. Light guided by the fiber 363 reaches the upper surface of the substrate 9 via the barrel, and reflected light thereof is received by the CCD image sensor via the objective lens. As a result of this, an image of the upper surface of the substrate 9 is captured. The CCD image sensor, which is electrically connected with the main computer 60, obtains data of captured image in accordance with instructions provided from the main computer 60, and transmits the data of captured image to the main computer 60. The alignment unit 361 may further include an auto-focusing unit which is capable of performing an auto-focus operation.

The optical unit 40 includes a light source 41 and two optical heads 42 (refer to FIG. 3), and serves as a light irradiation part for irradiating the substrate 9 with spatially-modulated light. The optical heads 42 spatially modulates laser light supplied from the light source 41. The light source 41 includes a laser driver 411, a laser oscillator 412 which supplies light, and an illumination optical system 413. The foregoing elements are provided for each of the optical heads 42. Upon operation of the laser driver 411, laser light is emitted from the laser oscillator 412, and then is introduced into each of the optical heads 42 via the illumination optical system 413.

Each of the optical heads 42 includes a spatial light modulator, an optical system, an irradiation position shift mechanism, and a projection optical system. The optical system guides light supplied from the light source 41 toward the spatial light modulator, which spatially modulates the guided light. The irradiation position shift mechanism includes a pair of wedge prisms, and shifts an optical axis by changing a distance between the pair of wedge prisms, to thereby relatively shift a position for drawing in the upper surface of the substrate 9 in the sub-scanning direction. The projection optical system guides light given from the irradiation position shift mechanism to the upper surface of the substrate 9.

The spatial light modulator is of a diffraction-grating type, and a reflection type, for example, and is formed as a diffraction grating, the grating depth of which is changeable. The spatial light modulator is manufactured using techniques for semiconductor device manufacturing. The light modulator of a diffraction-grating type used in the preferred embodiment is GLV (Grating Light Valve, a registered trademark of Silicon Light Machines in Sunnyvale, Calif.), for example. The use of GLV makes it possible to change an amount of light supplied to each pixel at multi-levels in accordance with control data for irradiation which is provided from the main computer 60. The spatial light modulator includes a plurality of grating elements, and each of the plurality of grating elements changes between a state in which first-order diffracted light is emitted and a state in which zero-order diffracted light is emitted. In the optical unit 40, first-order diffracted light is shielded by a light shielding board, and not guided to the substrate 9. On the other hand, zero-order diffracted light is guided to the substrate 9 via the irradiation position shift mechanism and the projection optical system.

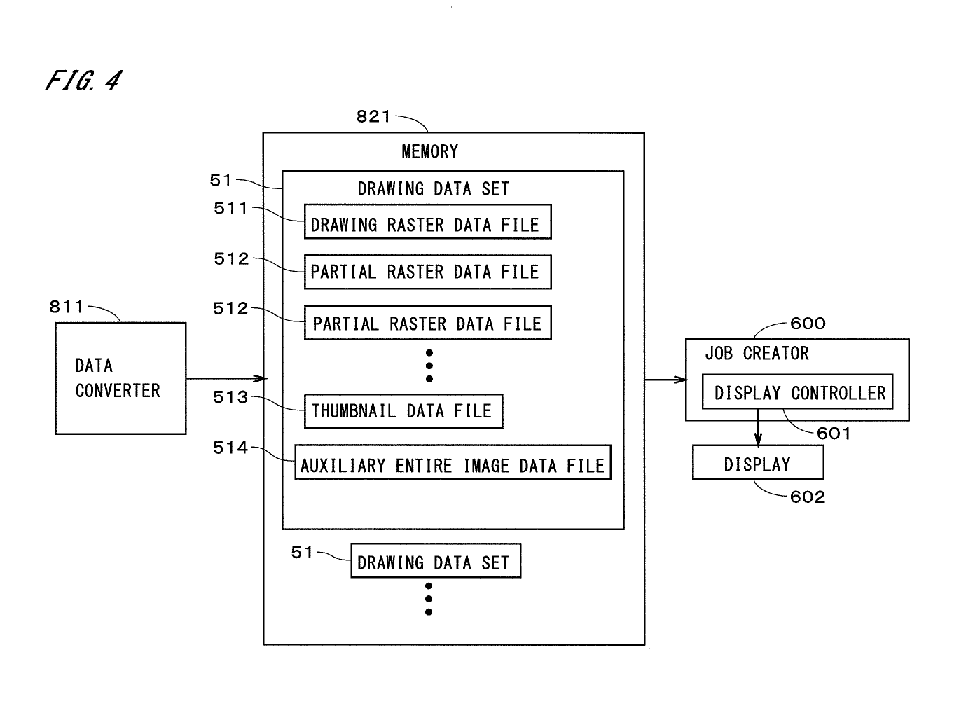

FIG. 4 is a functional block diagram of the drawing apparatus 1, illustrating functions thereof for generating and selecting data used for drawing. A data converter 811 illustrated in FIG. 4 is implemented by the CPU of the first computer 81 or the like, and a job creator 600 is implemented by the CPU of the main computer 60 or the like. Also, a memory 821 is implemented by a hard disk of the second computer 82 or the like, and a display 602 serving as a displaying part is provided in the main computer 60.

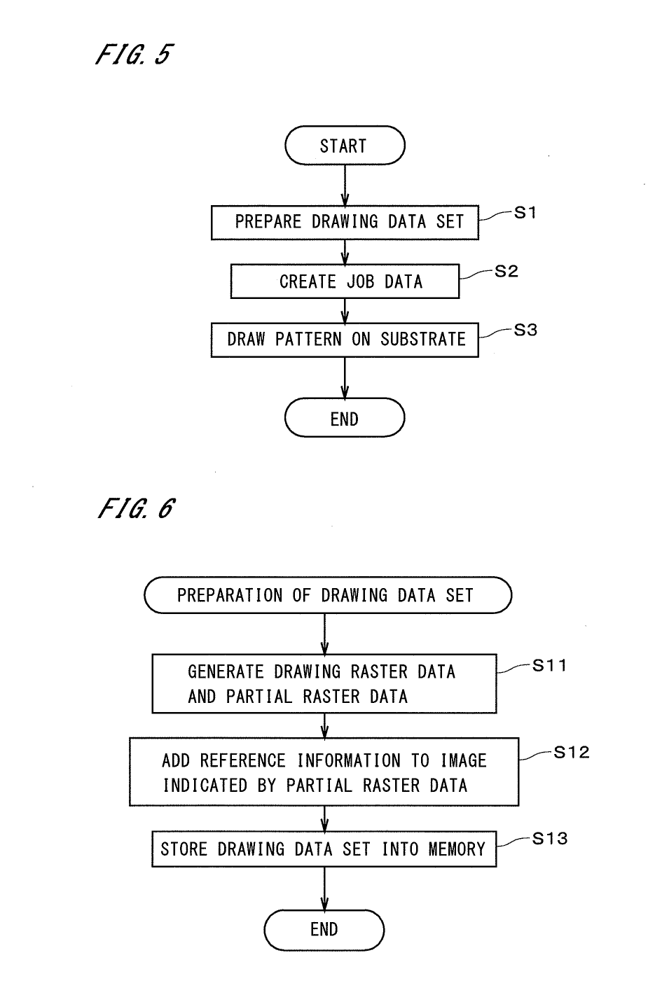

FIG. 5 is a flow chart illustrating a process of drawing a pattern on the substrate 9. In drawing a pattern on the substrate 9 in the drawing apparatus 1, a plurality of drawing data sets respectively corresponding to a plurality of patterns which are different from one another are previously prepared (step S1). Below, the step of preparing drawing data sets in the drawing apparatus 1 will be described with reference to FIG. 6.

For preparation of drawing data sets, first, vector data (CAD data) which indicates an entirety of a predetermined pattern (which will be hereinafter referred to as a “target pattern”) is created in an external computer (computer for CAD/CAM), and is input to the first computer 81 of the drawing apparatus 1. Specifically, upon execution of a predetermined program in the first computer 81 by an operator who is also a designer of the pattern, the data converter 811 illustrated in FIG. 4 causes the target pattern formed based on the vector data to appear on a display of the first computer 81. Subsequently, the operator determines a plurality of areas including features in the pattern (in other words, feature areas) via an input part with reference to the target pattern on the display, so that information indicating respective positions and sizes of the feature areas is received by the data converter 811.

Then, upon input of instructions for data conversion, the vector data is rasterized so that raster data (which indicates an entirety of the target pattern, and will be hereinafter referred to as “drawing raster data”) is generated and partial raster data indicating only each of feature areas in the target pattern is also generated (step S11). Further, data of a thumbnail indicating an entirety of the target pattern (raster data) and data of an auxiliary entire image which is an entire image having a resolution lower than that of an image indicated by the drawing raster data are generated in the data converter 811 (It is noted that the resolution of the auxiliary entire image is high enough to exceed the resolution of the thumbnail). Additionally, the resolution of an image indicated by the partial raster data is preferably as high as that of an image indicated by the drawing raster data.

According to the preferred embodiment, each of drawing raster data, partial raster data, data of a thumbnail, and data of an auxiliary entire image is generated as one data file, and thus, those will be also referred to as a drawing raster data file, a partial raster data file, a thumbnail data file, and an auxiliary entire image data file, respectively, in the following description. Also, coordinates of a feature area indicated by each partial raster data file in the target pattern are included in a file name of the partial raster data file. In other words, each of partial raster data files further includes information about a position of a feature area.

Subsequently, an image indicated by a partial raster data file appears on the display of the first computer 81. Then, the operator gives instructions for adding reference information such as a mark put on a portion which should be noted in its feature area, coloring of the portion, or comments about the feature area, via the input part, so that the partial raster data file is revised to a data file indicating an image obtained by adding reference information to an image showing the feature area (step S12). A partial raster data file is preferably generated in a typical image file format. By doing so, the function of generating partial raster data and the function of adding reference information to an image indicated by partial raster data can be easily implemented with the use of different programs, different computers and the like. Furthermore, partial raster data indicating an image obtained by adding reference information to an image showing a feature area may alternatively be generated in the step S11 by inputting contents of the reference information prior to generation of the partial raster data in the step S11.

In the data converter 811, a set of (a set including) drawing raster data file 511, a plurality of partial raster data files 512, a thumbnail data file 513, and an auxiliary entire image data file 514 which are associated with one another (refer to FIG. 4) is treated as a drawing data set 51, to be stored in a fixed disk or the like of the first computer 81. In practice, the drawing raster data file 511, the plurality of partial raster data files 512, the thumbnail data file 513, and the auxiliary entire image data file 514 included in one drawing data set 51 are stored in one data folder. The drawing data set 51 is output from the first computer 81 to the second computer 82, to be also stored in the memory 821 of the second computer 82 (step S13).

In the drawing apparatus 1, each time vector data indicating an entirety of a pattern is input to the first computer 81, the foregoing process in the steps S11, S12, and S13 is repeated, so that a plurality of drawing data sets 51 are stored and prepared in the memory 821. Illustration of repetition of the steps S11, S12, and S13 is omitted in FIG. 5. Additionally, all of the drawing data sets 51 which are generated in the first computer 81 are not necessarily stored in the memory 821. More specifically, in accordance with instructions given from the first computer 81, the second computer 82, or the main computer 60, only necessary drawing data sets 51 out of the plurality of drawing data sets 51 stored in the first computer 81 may be output to the second computer 82 and stored in the memory 821.

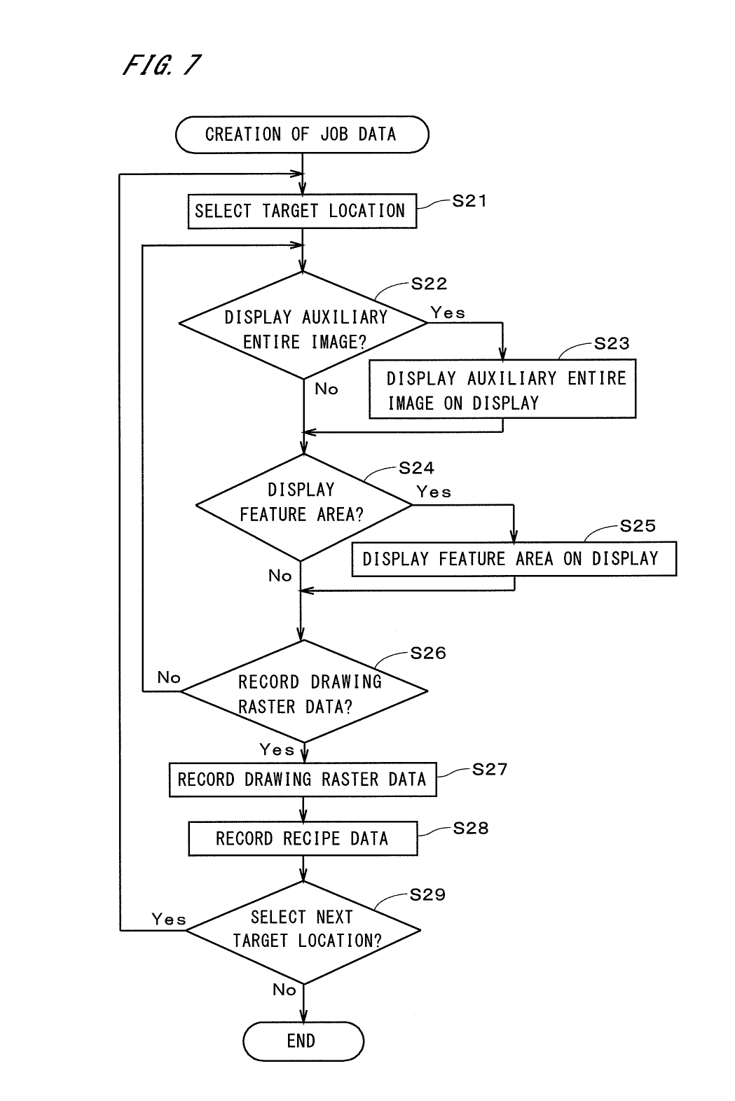

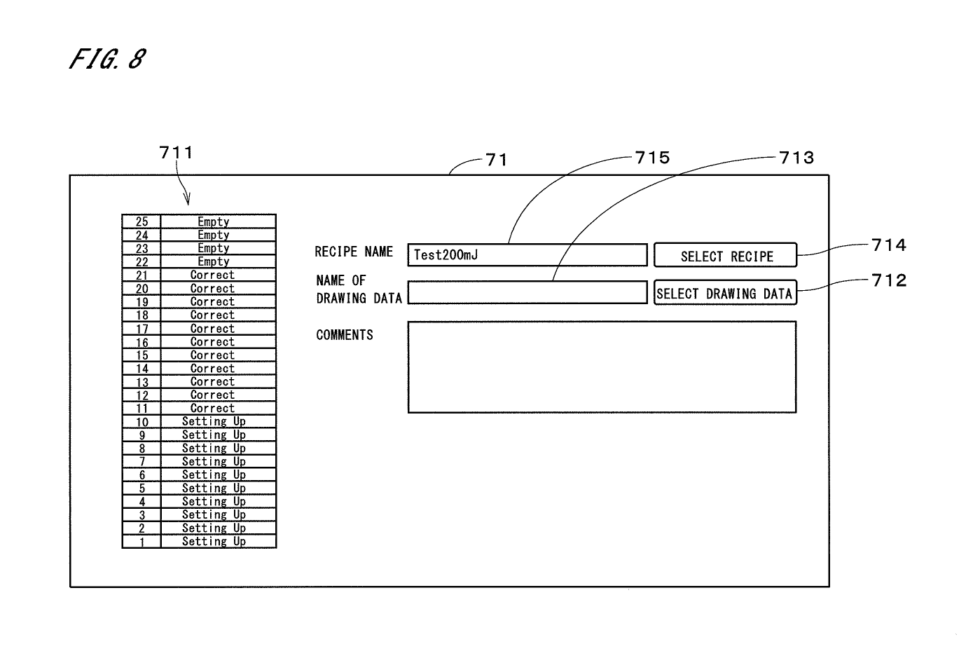

After the plurality of drawing data sets 51 are prepared, job data indicating patterns which are to be drawn on the a plurality of substrates 9 held in the cassette 90 and various conditions for drawing is created (refer to FIG. 5, step S2). Hereinafter, a process of creating the job data in the drawing apparatus 1 will be described with reference to FIG. 7.

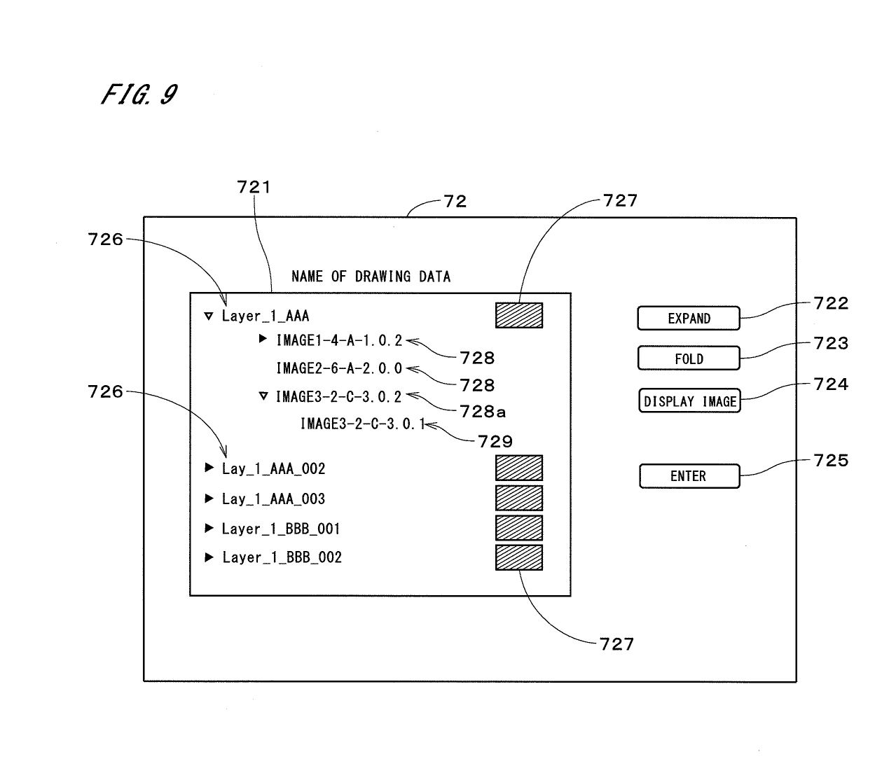

In creation of the job data according to the preferred embodiment, the designer of pattern and the operator are supposed to be different from each other (the designer of pattern and the operator may be the same person, of course). Upon execution of a predetermined program in the main computer 60 by the operator, a display controller 601 of the job creator 600 in FIG. 4 causes a job creation window 71 illustrated in FIG. 8 to appear on the display 602 of the main computer 60. The job creation window 71 includes a substrate selector 711. According to the preferred embodiment, twenty-five locations of substrates are provided in the cassette 90, and the locations in the cassette 90 can be designated by using the numbers from one to twenty-five in the substrate selector 711.

Subsequently, a desired number in the substrate selector 711 is selected by the operator via the input part (step S21). According to the preferred embodiment, a desired number is selected with a click of a mouse. In the following description, selection with a click of a mouse will be also simply referred to as a “click”. Of course, selection may alternatively been achieved by an input operation using a keyboard or the like. As a result of selection of the number in the substrate selector 711, recording of a pattern which is to be drawn on the substrate 9 placed at the location of the selected number (which will be hereinafter referred to as a “target location”) and recording of a recipe indicating various conditions for drawing at the time of drawing on the substrate 9 (for example, determination of an amount of light in drawing and designation of alignment marks) can be achieved by the following process. Additionally, plural numbers may alternatively be selected in the step S21. In this case, the following process is performed while treating a set of locations of the selected plural numbers as a target location.

After a target location is selected, with a click on a drawing data selection button 712 in the job creation window 71, a drawing data selection window 72 appears on the display 602 as illustrated in FIG. 9. In a file name display area 721 of the drawing data selection window 72, respective file names (indicated by arrows denoted with a reference numeral “726” in FIG. 9) of the drawing raster data files 511 in all of the drawing data sets 51 stored in the memory 821 of the second computer 82 are displayed. At that time, the partial raster data files 512, the thumbnail data files 513, and the auxiliary entire image data files 514 which are included in the drawing data sets 51 are transmitted to the main computer 60, to be stored in a memory of the main computer 60. Also, on the right side of each of the file names 726 of the drawing raster data files 511 in the drawing data selection window 72, a thumbnail 727 indicated by the thumbnail data file 513 included in the same drawing data set 51 that includes the corresponding drawing raster data file 511, is displayed. Additionally, other information such as a creation date of each of the drawing raster data files 511 may be displayed in the file name display area 721.

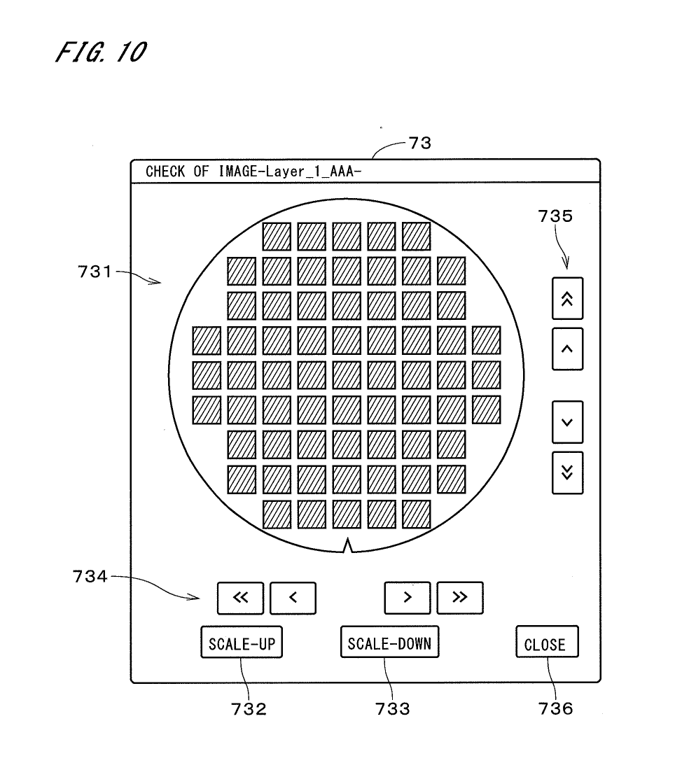

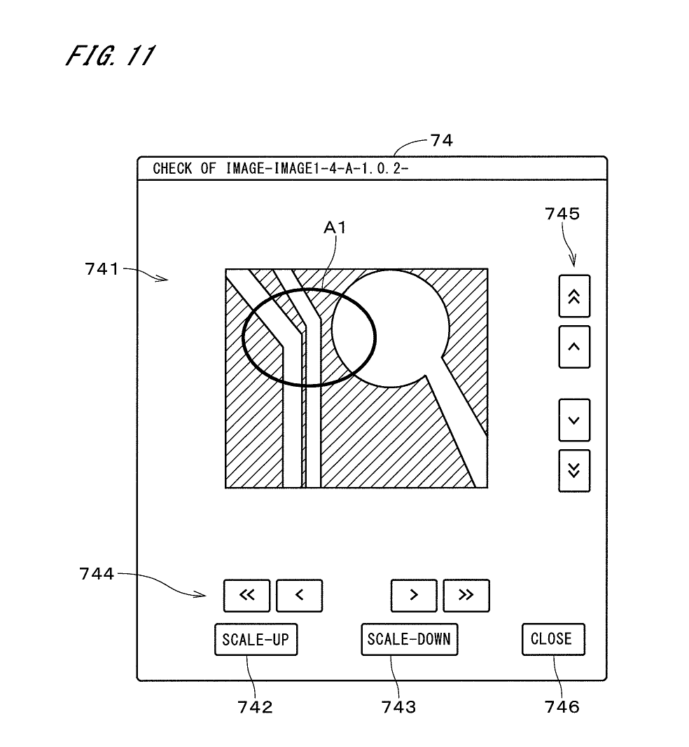

After one of the file names 726 of the drawing raster data files 511 is selected in the drawing data selection window 72, with a click on an image display button 724, an entire image window 73 appears on the display 602 as illustrated in FIG. 10 (steps S22 and S23). The entire image window 73 includes an image display area 731, where an image indicated by the auxiliary entire image data file 514 (that is, an auxiliary entire image) included in the same drawing data set 51 that includes the corresponding drawing raster data file 511, is displayed. The displayed image shows an entirety of a pattern. The entire image window 73 also includes a scale-up button 732 and a scale-down button 733, with which an image displayed in the image display area 731 can be scaled up and down. The entire image window 73 further includes a lateral movement button group 734 and a longitudinal movement button group 735, with which a position of an area in a pattern displayed in the image display area 731 can be changed. Moreover, with a click on a close button 736 on which characters “CLOSE” are written, the entire image window 73 closes.

On the other hand, after one of the file names 726 of the drawing raster data files 511 is selected in the drawing data selection window 72 in FIG. 9, with a click on an expansion button 722, file names 728 (however, please note that in FIG. 9, one of the file names is denoted by a reference numeral “728a”) of the plurality of partial raster data files 512 appear under the selected file name 726. Either a black triangle or a white triangle is displayed in front of each of the file names 726 of the drawing raster data files 511. The black triangle indicates a state in which the file names 728 of the partial raster data files 512 included in the same drawing data set 51 that includes the corresponding drawing raster data file 511 are not displayed in the file name display area 721 (in other words, “folded” state). On the other hand, a white triangle indicates a state in which the file names 728 of the partial raster data files 512 included in the same drawing data set 51 that includes the corresponding drawing raster data file 511 are displayed in the file name display area 721 (in other words, “expanded” state).

Further, in a state in which the file names 728 of the partial raster data files 512 are displayed, with a click on a folding button 723, the state can be changed to a state in which the file names 728 of the partial raster data files 512 are not displayed. Moreover, referring to FIG. 9, either a black triangle or a white triangle is displayed also in front of some of the file names 728 of the partial raster data files 512, similarly to the file names 726 of the drawing raster data files 511. Furthermore, though a file name 729 of the other partial raster data file 512 is displayed under the file name 728a of the partial raster data file 512 to which a white triangle is added, details of the other partial raster data file 512 will be later given.

After one of the file names 728 of the partial raster data files 512 is selected in the drawing data selection window 72, with a click on an image display button 724, a feature area window 74 appears on the display 602 as illustrated in FIG. 11 (steps S24 and S25). The feature area window 74 includes an image display area 741, where an image indicated by the selected partial raster data file 512 is displayed, to show a feature area. As described above, an image indicated by the partial raster data file 512 further includes reference information, and thus, a circle A1 serving as a mark indicating a portion which should be noted in the feature area is displayed in FIG. 11.

In the drawing apparatus 1, an image in the image display area 741 is visually recognized by the operator. Specifically, an image showing a feature area of a pattern which is to be drawn on the substrate 9 placed at a target location is previously prepared in a state the image is printed on a printing paper, and the image on the printing paper and the image in the image display area 741 are compared with each other. In this way, whether or not the drawing raster data file 511 included in the same drawing data set 51 that includes the corresponding partial raster data file 512 indicates the pattern which is to be drawn on the substrate 9 placed at the target location is checked. According to the example described here, an image of the partial raster data file 512 having a file name, “IMAGE 1-4-A-1.0.2”, in FIG. 9, appears on the display 602, and whether or not the drawing raster data file 511 having a file name, “Layer_{—}1_AAA” indicates a desired pattern is checked.

In practice, after the file names 728 of the plurality of partial raster data files 512 are selected in the drawing data selection window 72 in FIG. 9, with a click on the image display button 724, it is possible to cause the plurality of feature area windows 74 showing a plurality of feature areas to simultaneously appear on the display 602. Thus, to display a plurality of feature areas corresponding to the same drawing raster data file 511 allows a pattern indicated by the drawing raster data file 511 to be reliably checked.

The feature area window 74, as well as the entire image window 73, includes a scale-up button 742 and a scale-down button 743, with which an image displayed in the image display area 741 can be scaled up and down. The feature area window 74 further includes a lateral movement button group 744 and a longitudinal movement button group 745, with which a position of an area in a pattern displayed in the image display area 741 can be changed. Moreover, with a click on a close button 746 on which characters

“CLOSE” are written, the feature area window 74 closes.

As a result of the foregoing process, or alternatively, as a result of repetition (step S26) of either display of an auxiliary entire image corresponding to another drawing raster data file 511 (steps S22 and S23) or display of the feature area (steps S24 and S25) as needed, the drawing raster data file 511 indicating a pattern which is to be drawn on the substrate 9 placed at the target location is designated. Subsequently, the file name 726 of the designated drawing raster data file 511 is selected in the drawing data selection window 72 in FIG. 9. Then, with a click on an enter button 725, the file name of the designated drawing raster data file 511 is displayed on a drawing data recording section 713 in the job creation window 71 illustrated in FIG. 8, so that the designated drawing raster data file 511 is recorded (steps S26 and S27).

Further, with a click on a recipe selection button 714 in the job creation window 71, a window showing file names of a plurality of recipe data files which are previously recorded appear, and one of the a plurality of recipe data files is selected by the operator. In this way, the file name of the selected recipe data file is displayed on a recipe recording section 715 in the job creation window 71 in FIG. 8, so that the selected recipe data file is recorded (step S28). As described above, a recipe data file indicates various conditions for drawing in the drawing part 100. As a result of the foregoing process, recording of a pattern which is to be drawn on the substrate 9 placed at the target location and recording of a recipe indicating conditions for drawing at the time of drawing on the substrate 9 are completed. Additionally, recording of a recipe data file may alternatively be achieved prior to recording of the drawing raster data file 511.

In the drawing apparatus 1, the steps S21 through S28 are repeated (step S29) until recording of the drawing raster data files 511 for all of locations in the cassette 90 and recording of recipe data files are completed. As a result, job data is created.

Meanwhile, during creation of the job data, if a location where the substrate 9 is not placed is present, an input for giving instructions for ignoring such the location is provided.

After the job data is created by the foregoing process, a pattern is drawn in accordance with the job data (refer to FIG. 5, step S3). In drawing a pattern in the drawing part 100 illustrated in FIGS. 2 and 3, the substrate 9 which is to be firstly processed in the cassette 90 is carried out from the cassette 90 by the carrier device 110, to be placed on the stage 10. Subsequently, based on an output provided by the alignment unit 361, the rotation mechanism 21 is controlled so that the substrate 9 is aligned (properly positioned) in an orientation suitable for drawing a pattern on the substrate 9.

Also, the main computer 60 outputs a data request signal to the second computer 82 in accordance with the job data, stripe data which is drawing data of one stripe (one swath) on the substrate 9 is generated from the drawing raster data file 511 recorded for the firstly-processed substrate 9, in the second computer 82. The stripe data is data for controlling the spatial light modulator of the optical unit 40 and the stage movement mechanism 20, and is input from the second computer 82 to the main computer 60. In the drawing part 100, the optical heads 42 of the optical unit 40 and the stage movement mechanism 20 are controlled in accordance with the stripe data and a recipe data file recorded for the substrate 9, to achieve pattern drawing.

More specifically, the main scanning mechanism 25 causes the substrate 9 to start moving in the main scanning direction parallel to the main surface thereof. Then, in parallel with the movement of the substrate 9 relative to the optical unit 40, emission of spatially-modulated light from the two optical heads 42 to the substrate 9 is started from the head portions of areas corresponding to two stripes (which will be hereinafter referred to as “stripe areas”). In this way, drawing of a pattern is started. When drawing on the stripe areas up to the tail portions thereof is achieved, emission of light from the optical heads 42 temporarily stops, and also the movement of the substrate 9 in the main scanning direction is stopped. The sub-scanning mechanism 23 causes the substrate 9 to travel only a distance equal to a width of the stripe area in the sub-scanning direction which is perpendicular to the main scanning direction and is parallel to the main surface of the substrate 9. Then, while the substrate 9 is moving in a direction reverse to a direction for the previous main scanning of the substrate 9, drawing on two stripe areas is achieved by the two optical heads 42. After drawing on all stripe areas is completed by repeated movement of the substrate 9 in the main scanning direction and the sub-scanning direction, the substrate 9 is carried out by the carrier device 110, to be housed in the cassette 90. Each of the optical heads 42 is responsible for drawing a pattern on a half of the substrate 9.

After drawing of a pattern on the substrate 9 is completed by the foregoing process, a pattern is drawn on the substrate 9 which is the next to be processed, in the same manner as described above. In the drawing apparatus 1, by the repetition of the foregoing process, drawing of pattern on all the substrates 9 which are to be processed and housed in the cassette 90 is achieved.

In the meantime, in a case where a pattern element formed on the substrate 9 does not have a desired line width or in a case where a corner portion of a pattern element does not have a desired shape, for example, it is necessary to revise (or modify) a pattern, to again generate data used for drawing (drawing raster data). Like the foregoing cases, in a case where it is necessary to revise a pattern corresponding to one drawing data set 51 (which will hereinafter be referred to as a “target drawing data set 51”), vector data indicating a revised version of the pattern, i.e., a revised pattern, is generated in an external computer, and is input to the first computer 81. Then, the data converter 811 rasterizes the vector data indicating an entirety of the revised pattern, to generate new drawing raster data (which will be hereinafter referred to as “revised drawing raster data” when discrimination from drawing raster data indicating an entirety of unrevised pattern is needed).

Further, the data converter 811 is capable of obtaining coordinates of a feature area indicated by each of the partial raster data files 512 included in the target drawing data set 51, with reference to the file name of each of the partial raster data files 512. It is noted that “the partial raster data files 512 included in the target drawing data set 51” in the foregoing sentence means the partial raster data files 512 for an unrevised pattern, and will be hereinafter also referred to as “unrevised partial raster data files 512”. In this way, at the time of generating revised drawing raster data, partial raster data indicating the same feature area as is indicated by the unrevised partial raster data, in the revised pattern, is also generated (refer to FIG. 6, step S11). The partial raster data in this regard will hereinafter be referred to as “revised partial raster data” when discrimination from unrevised partial raster data is needed. At that time, a revised number of a pattern (revision number) is included in the file name of the revised partial raster data file. Additionally, revised partial raster data may alternatively be generated by using information about a position of a feature area indicated by each of the partial raster data files 512, which is separately stored in the first computer 81. Also, partial raster data indicating a new feature area may be generated.

Subsequently, reference information is added to an image indicated by the revised partial raster data as needed (step S12). Then, in the memory 821 of the second computer 82, the original drawing raster data is replaced with the revised drawing raster data to be revised in the target drawing data set 51. Also, both of the unrevised partial drawing raster data and the revised partial drawing raster data are included in the target drawing data set 51 (step S13).

Referring to FIG. 7, in steps S24 and S25, while the file name 728a of a revised partial raster data is appearing in the drawing data selection window 72 in FIG. 9, with a click on the expansion button 722 after selection of the file name 728a of the revised partial raster data, a file name 729 of an unrevised partial raster data file is displayed under the file name 728a (the file name 729 has already been included in FIG. 9). Then, with a click on the image display button 724 after selection of the file name 729 of the unrevised partial raster data file, the feature area window 74 as is illustrated in FIG. 11 appears on the display 602. The feature area window 74 includes the image display area 741, where an image indicated by the unrevised partial raster data file is displayed, and shows the feature area in the unrevised pattern. Accordingly, to display both of the feature area window 74 for the unrevised partial raster data file and the feature area window 74 for the revised partial raster data file allows comparison of respective feature areas in the unrevised pattern and the revised pattern (which have different line widths, for example).

In this paragraph, a drawing apparatus according to a comparative example will be described. In the drawing apparatus according to the comparative example, a partial raster data file is not generated, so that it is impossible to cause the feature area window 74 illustrated in FIG. 11 to appear on a display in creation of job data in the step S2 of FIG.

5. Accordingly, in order for the operator to check a pattern indicated by a selected drawing raster data file 511, it is necessary to cause the entire image window 73 illustrated in FIG. 10 to appear on the display and repeat scaling-up/down or movement of an image displayed in the image display area 731 many times to find out a feature area which is to be checked. Thus, a long period of time is required for an operation for checking.

On the contrary to this, in the drawing apparatus 1, in generating drawing raster data by rasterizing vector data indicating an entirety of each of patterns, partial raster data which is data indicating a feature area for pattern identification in each of the patterns is generated. Then, in selecting a pattern which is to be drawn (in other words, selection of drawing raster data), an image showing a feature area in a selected pattern out of a plurality of patterns is displayed on the display 602, based on the partial raster data included in the same drawing data set 51 that includes the drawing raster data indicating the selected pattern. Thus, it is possible to display an image showing the feature area in the selected pattern speedily and easily, so that the operator can efficiently check correctness/incorrectness of the selected pattern (in other words, whether or not the selected pattern is a pattern which is to be drawn). Also, as the designer of a pattern or the like prepares an instruction sheet on which the file name of drawing raster data which is to be selected in an actual pattern drawing and an image indicated by the partial raster data included in the same drawing data set 51 that includes the drawing raster data are printed, even an operator who does not have information about a pattern which is to be drawn can reliably check correctness/incorrectness of a pattern by referring to the instruction sheet with an image showing a feature area being displayed. As a result, it is possible to prevent an incorrect file name from being selected and to prevent an incorrect pattern from being drawn on the substrate 9.

Also, raster data indicating an image obtained by adding reference information to an image showing a feature area is used as partial raster data in the drawing data set 51. This makes it possible to speedily display an image which shows a feature area and further includes the reference information, so that drawing of an incorrect pattern can be more successfully prevented.

Further, in revising a pattern corresponding to one drawing data set 51, revised partial raster data indicating a feature area in a revised pattern is generated, and when the revised pattern is selected in creating job data, an image indicated by unrevised partial raster data and an image indicated by revised partial raster data can be displayed on the display 602. This makes it possible to easily display images respectively showing feature areas in the unrevised and revised patterns, so that a pattern which is to be drawn can be more reliably checked.

In the drawing apparatus 1, each of the drawing data sets 51 includes partial raster data indicating each of a plurality of feature areas, and when a pattern corresponding to each of the drawing data sets 51 is selected, a plurality of images showing the a plurality of feature areas in the selected pattern can be individually displayed on the display 602. As a result, the operator can visually recognize the plurality of feature areas in each of the patterns easily, to thereby more reliably check whether or not a pattern is to be drawn.

While the preferred embodiment of the present invention has been described as above, the present invention is not limited to the foregoing description and various modifications are possible.

According to the above-described preferred embodiment, partial raster data which is raster data indicating a feature area is generated in the data converter 811. Alternatively, partial vector data which is vector data indicating a feature area may be generated by using vector data indicating an entirety of a pattern. In this alternative case, the display controller 601 of the job creator 600 causes an image showing a feature area in a selected pattern to be displayed on the display 602, based on partial vector data included in the same drawing data set 51 that includes drawing raster data indicating the selected pattern. The size of the partial vector data is small enough to speedily display the image showing the feature area in the selected pattern.

Also, positional data of a feature area(s) may be generated in place of partial raster data in the data converter 811. In this alternative case, a portion showing each feature area is extracted from drawing raster data indicating a selected pattern, based on positional data included in the same drawing data set 51 that includes the drawing raster data indicating the selected pattern, and an image showing the feature area in the selected pattern is speedily displayed on the display 602. As described above, in the drawing apparatus 1, at the time of generating drawing raster data indicating each of patterns, positional data of a feature area(s) for pattern identification in each of the patterns, or partial data which is data indicating the feature area (in other words, partial raster data or partial vector data), is generated. Then, the drawing raster data and either the positional data or the partial data are collected as the drawing data set 51 to be stored in the memory 821, so that an image showing the feature area in the selected pattern (in other words, the selected drawing raster data) can be speedily and easily displayed based on the positional data or the partial data. Of course, the drawing data set 51 may include positional data of a plurality of feature areas.

An image showing a feature area may be displayed any time except the time of creating job data. For example, an image showing a feature area may be displayed at the time of checking contents of created job data just before drawing a pattern on the substrate, based on positional data or partial data included in the drawing data set 51.

Also, the drawing data set 51 may be generated in the second computer 82 or the main computer 60, and a plurality of drawing data sets 51 may be stored in the memory of the first computer 81 or the main computer 60. Further, a feature area may be displayed on the displaying part of the first computer 81 or the second computer 82 based on positional data of the feature area or partial data indicating the feature area. Moreover, generation and storage of the drawing data set 51 and display of a feature area may be implemented by one, two, or four and more computers, and either a part or a whole of the foregoing processes may be implemented by using a dedicated electrical circuit.

An object on which a pattern is to be drawn in accordance with drawing raster data by the drawing part 100 may include a film having a photosensitive layer formed thereon, or the like, in addition to the substrate 9. Also, the optical head in the drawing part 100 may have any other structure if capable of emitting modulated light. Further, the drawing part may draw a pattern with the use of an electron beam or the like.

The above-described structures in the preferred embodiment and the various modifications can be appropriately combined with each other unless contradiction arises.

While the invention has been shown and described in detail, the foregoing description is in all aspects illustrative and not restrictive. It is therefore understood that numerous modifications and variations can be devised without departing from the scope of the invention. This application claims priority benefit under 35 U.S.C. Section 119 of Japanese Patent Application No. 2011-194848 filed in the Japan Patent Office on Sep. 7, 2011, the entire disclosure of which is incorporated herein by reference.

### REFERENCE SIGNS LIST

1 Drawing apparatus

9 Substrate

51 Drawing data set

100 Drawing part

511 Drawing raster data file

512 Partial raster data file

601 Display controller

602 Display

741 Image display area

811 Data converter

821 Memory

A1 Circle

S3, S11, S13, and S24 Steps

1. A drawing apparatus for drawing a pattern, comprising:
a data converter for generating drawing raster data by rasterizing vector data indicating an entirety of each pattern, and generating positional data of a feature area included in said each pattern or partial data indicating said feature area at the time of generating said drawing raster data, said feature area being used for pattern identification;
a memory for storing a plurality of drawing data sets respectively corresponding to a plurality of patterns, each of said plurality of drawing data sets including a set of said drawing raster data, and said positional data or said partial data;
a display controller for displaying an image showing a feature area in a selected pattern out of said plurality of patterns, on a displaying part, based on positional data or partial data which is included in the same drawing data set that includes drawing raster data indicating said selected pattern; and
a drawing part for drawing a pattern on an object in accordance with drawing raster data.

2. The drawing apparatus according to claim 1, wherein
partial data included in one drawing data set is raster data which indicates an image obtained by adding reference information to an image showing a feature area.

3. The drawing apparatus according to claim 1, wherein
one drawing data set includes drawing raster data and partial raster data,
in revising a pattern corresponding to said drawing data set, said data converter generates revised drawing raster data by rasterizing vector data indicating an entirety of a revised pattern, and generates revised partial raster data at the time of generating said revised drawing raster data, said revised partial raster data indicating the same feature area in said revised pattern as is indicated by said partial raster data,
said drawing raster data is revised to said revised drawing raster data in said drawing data set, and said drawing data set includes both of said partial raster data and said revised partial raster data, and
when said revised pattern is selected, an image indicated by said partial raster data and an image indicated by said revised partial raster data are ready for being displayed on said displaying part by said display controller.

4. The drawing apparatus according to claim 2, wherein
one drawing data set includes drawing raster data and partial raster data,
in revising a pattern corresponding to said drawing data set, said data converter generates revised drawing raster data by rasterizing vector data indicating an entirety of a revised pattern, and generates revised partial raster data at the time of generating said revised drawing raster data, said revised partial raster data indicating the same feature area in said revised pattern as is indicated by said partial raster data,
said drawing raster data is revised to said revised drawing raster data in said drawing data set, and said drawing data set includes both of said partial raster data and said revised partial raster data, and
when said revised pattern is selected, an image indicated by said partial raster data and an image indicated by said revised partial raster data are ready for being displayed on said displaying part by said display controller.

5. The drawing apparatus according to claim 1, wherein
each drawing data set includes positional data of a plurality of feature areas or partial raster data indicating each of said plurality of feature areas, and
when a pattern corresponding to said each drawing data set is selected, a plurality of images respectively showing a plurality of feature areas in said pattern are ready for being individually displayed on said displaying part by said display controller.

6. The drawing apparatus according to claim 2, wherein
each drawing data set includes positional data of a plurality of feature areas or partial raster data indicating each of said plurality of feature areas, and
when a pattern corresponding to said each drawing data set is selected, a plurality of images respectively showing a plurality of feature areas in said pattern are ready for being individually displayed on said displaying part by said display controller.

7. The drawing apparatus according to claim 3, wherein
each drawing data set includes positional data of a plurality of feature areas or partial raster data indicating each of said plurality of feature areas, and
when a pattern corresponding to said each drawing data set is selected, a plurality of images respectively showing a plurality of feature areas in said pattern are ready for being individually displayed on said displaying part by said display controller.

8. The drawing apparatus according to claim 4, wherein
each drawing data set includes positional data of a plurality of feature areas or partial raster data indicating each of said plurality of feature areas, and
when a pattern corresponding to said each drawing data set is selected, a plurality of images respectively showing a plurality of feature areas in said pattern are ready for being individually displayed on said displaying part by said display controller.

9. A drawing method for drawing a pattern, comprising the steps of:
a) generating drawing raster data by rasterizing vector data indicating an entirety of each pattern, and generating positional data of a feature area included in said each pattern or partial data indicating said feature area at the time of generating said drawing raster data, said feature area being used for pattern identification;
b) storing a plurality of drawing data sets respectively corresponding to a plurality of patterns in a memory, each of said plurality of drawing data sets including a set of said drawing raster data, and said positional data or said partial data;
c) displaying an image showing a feature area in a selected pattern out of said plurality of patterns, on a displaying part, based on positional data or partial data which is included in the same drawing data set that includes drawing raster data indicating said selected pattern; and
d) drawing a pattern on an object in accordance with drawing raster data.

10. The drawing method according to claim 9, wherein
partial data included in one drawing data set is raster data which indicates an image obtained by adding reference information to an image showing a feature area.

11. The drawing method according to claim 9, wherein
one drawing data set includes drawing raster data and partial raster data,
in revising a pattern corresponding to said drawing data set, revised drawing raster data is generated by rasterizing vector data indicating an entirety of a revised pattern, and revised partial raster data is generated at the time of generating said revised drawing raster data, said revised partial raster data indicating the same feature area in said revised pattern as is indicated by said partial raster data,
said drawing raster data is revised to said revised drawing raster data in said drawing data set, and said drawing data set includes both of said partial raster data and said revised partial raster data, and
when said revised pattern is selected, an image indicated by said partial raster data and an image indicated by said revised partial raster data are ready for being displayed on said displaying part.

12. The drawing method according to claim 10, wherein
one drawing data set includes drawing raster data and partial raster data,
in revising a pattern corresponding to said drawing data set, revised drawing raster data is generated by rasterizing vector data indicating an entirety of a revised pattern, and revised partial raster data is generated at the time of generating said revised drawing raster data, said revised partial raster data indicating the same feature area in said revised pattern as is indicated by said partial raster data,
said drawing raster data is revised to said revised drawing raster data in said drawing data set, and said drawing data set includes both of said partial raster data and said revised partial raster data, and
when said revised pattern is selected, an image indicated by said partial raster data and an image indicated by said revised partial raster data are ready for being displayed on said displaying part.

13. The drawing method according to claim 9, wherein
each drawing data set includes positional data of a plurality of feature areas or partial raster data indicating each of said plurality of feature areas, and
when a pattern corresponding to said each drawing data set is selected, a plurality of images respectively showing a plurality of feature areas in said pattern are ready for being individually displayed on said displaying part.

14. The drawing method according to claim 10, wherein
each drawing data set includes positional data of a plurality of feature areas or partial raster data indicating each of said plurality of feature areas, and
when a pattern corresponding to said each drawing data set is selected, a plurality of images respectively showing a plurality of feature areas in said pattern are ready for being individually displayed on said displaying part.

15. The drawing method according to claim 11, wherein
each drawing data set includes positional data of a plurality of feature areas or partial raster data indicating each of said plurality of feature areas, and
when a pattern corresponding to said each drawing data set is selected, a plurality of images respectively showing a plurality of feature areas in said pattern are ready for being individually displayed on said displaying part.

16. The drawing method according to claim 12, wherein
each drawing data set includes positional data of a plurality of feature areas or partial raster data indicating each of said plurality of feature areas, and
when a pattern corresponding to said each drawing data set is selected, a plurality of images respectively showing a plurality of feature areas in said pattern are ready for being individually displayed on said displaying part.
